(19) United States
(12) Patent Application Publication
(10) Pub. No.: US 2005/0084652 A1
(43) Pub. Date: Apr. 21, 2005

(54) Absorbent article with breathable backsheet comprising occluding fluid passageways

(75) Inventor: Guido Bonelli, Pescara (IT)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/689,399

(22) Filed: Oct. 20, 2003

(51) Int. Cl. B32B 3/10

(52) U.S. Cl. 428/137

(57) ABSTRACT

A resilient, three dimensional, fluid pervious polymeric web and an absorbent article with a breathable backsheet including the same are described. The resilient, three dimensional, fluid pervious polymeric web includes a first surface and a second surface generally parallel to and spaced apart from the first surface. The polymeric web also includes a plurality of fluid passageways comprising side walls extending between the first surface and the second surface to place the first surface and the second surface in fluid communication with one another. The polymeric web further includes an occluding material, which causes a mechanical change in the sidewalls of the fluid passageways upon contact with fluid rendering the first surface and the second surface to be in non-fluid communication with one another at the fluid passageways.

### FIELD OF INVENTION

This invention relates to a resilient, three dimensional, fluid pervious polymeric web and absorbent articles with a breathable backsheet that comprises the same.

### BACKGROUND OF THE INVENTION

The development of absorbent articles is driven by at least two needs of the consumer, protection and comfort. Breathable backsheets in absorbent articles are designed to provide a comfort benefit to consumers. An example of breathable backsheets, includes microporous films and apertured formed films both having directional fluid transfer, such as disclosed in U.S. Pat. No. 4,591,523 issued to Thompson. Both of these types of breathable backsheets are air and vapor permeable, allowing gaseous exchange with the environment and increased circulation within the absorbent article, so that a portion of the fluid collected in the core evaporates. Although in principle breathable backsheets only allow the transfer of materials in the gaseous state, physical mechanisms such as extrusion, diffusion and capillary action, may still occur and result in the transfer of the fluids from the absorbent core through the backsheet and onto the users garments. One attempt to solve the problem of compromised consumer protection, is the use of a dual backsheet having one layer with slanted capillary apertures, such as disclosed in U.S. Pat. No. 6,413,247 issued to Carlucci, et al.

Despite attempts by those skilled in the art to provide an acceptable level of protection with the use of breathable backsheets, current films or webs used for breathable backsheets are too flexible to remain breathable when dry or are too rigid to close apertures and become pervious when wetted. The inventors believe that the polymeric web and the breathable backsheet of the present invention are both comfortable and provide an acceptable level of protection for the consumer. The present invention comprises polymeric web that has a plurality of fluid passageways comprising side walls extending between surfaces of the web. The polymeric web comprises an occluding material, which causes a mechanical change in the sidewalls of the fluid passageways upon contact with fluid rendering the surfaces of the web to be in non-fluid communication with one another, thus providing an effective leakage barrier.

### SUMMARY OF THE INVENTION

The present invention includes a resilient, three dimensional, fluid pervious polymeric web and an absorbent article with a breathable backsheet comprising the same. The resilient, three dimensional, fluid pervious polymeric web has a first surface and a second surface generally parallel to and spaced apart from the first surface. The polymeric web also has a plurality of fluid passageways comprising side walls extending between the first surface and the second surface to place the first surface and the second surface in fluid communication with one another. The polymeric web further includes an occluding material, which causes a mechanical change in the sidewalls of the fluid passageways upon contact with fluid rendering the first surface and the second surface to be in non-fluid communication with one another at the fluid passageways.

### BRIEF DESCRIPTION OF THE DRAWINGS

FIG. 1 shows a partial cut away plan view of an absorbent article comprising the breathable backsheet of the present invention.

FIG. 2 shows a transverse cross-section of an absorbent article comprising the breathable backsheet of the present invention.

FIG. 3 shows a cross section of a fluid passageway of the three dimensional, fluid pervious polymeric web.

FIG. 4A shows a cross section of a fluid passageway of the three dimensional, fluid pervious polymeric web with the occluding material totally exposed at the first opening of the fluid passageway.

FIG. 4B shows a cross section of a fluid passageway of the three dimensional, fluid pervious polymeric web with the occluding material partially exposed at the first opening of the fluid passageway.

FIG. 4C shows a cross section of a fluid passageway of the three dimensional, fluid pervious polymeric web with the occluding material unexposed at the first opening of the fluid passageway.

FIG. 5 shows a cross section of a fluid passageways of the three dimensional, fluid pervious polymeric web.

### DETAILED DESCRIPTION OF THE INVENTION

As used herein, the term “bicomponent fibers” refers to fibers that have been formed from at least two different polymers extruded from separate extruders but spun together to form one fiber. Bicomponent fibers are also sometimes referred to as conjugate fibers or multicomponent fibers. The polymers are arranged in substantially constantly positioned distinct zones across the cross-section of the bicomponent fibers and extend continuously along the length of the bicomponent fibers. The configuration of such a bicomponent fiber may be, for example, a sheath/core arrangement wherein one polymer is surrounded by another or may be a side-by-side arrangement, a pie arrangement or an “islands-in-the-sea” arrangement.

As used herein, the term “biconstituent fibers” refers to fibers that have been formed from at least two polymers extruded from the same extruder as a blend. Biconstituent fibers do not have the various polymer components arranged in relatively constantly positioned distinct zones across the cross-sectional area of the fiber and the various polymers are usually not continuous along the entire length of the fiber, instead usually forming fibrils which start and end at random. Biconstituent fibers are sometimes also referred to as multiconstituent fibers.

As used herein, the term “capillary channel fibers” refers to fibers having capillary channels capable of facilitating fluid movement via capillarity. Such fibers can be hollow fibers, for example, but are preferably fibers having capillary channels on their outer surfaces. The capillary channels can be of various cross-sectional shapes such as “U-shaped,” “H-shaped,” “C-shaped,” and “V-shaped.”

The term “joined” or “attached,” as used herein, encompasses configurations in which a first element is directly secured to a second element by affixing the first element directly to the second element; configurations in which the first element is indirectly secured to the second element by affixing the first element to intermediate member(s) which in turn are affixed to the second element; and configurations in which the first element is integral with the second element; i.e., the first element is essentially part of the second element.

As used herein, the term “meltblowing” refers to a process in which fibers are formed by extruding a molten thermoplastic material through a plurality of fine, usually circular, die capillaries as molten threads or filaments into converging high velocity, usually heated, gas (for example air) streams which attenuate the filaments of molten thermoplastic material to reduce their diameter, which may be as small as microfibers. Thereafter, the meltblown fibers are carried by the high velocity gas stream and are deposited on a collecting surface, often while still tacky, to form a web of randomly dispersed meltblown fibers. Meltblown fibers are microfibers, which may be continuous or discontinuous and are generally smaller than 10 microns in average diameter.

As used herein, the term “monocomponent” fiber refers to a fiber formed from one or more extruders using only one polymer. This is not meant to exclude fibers formed from one polymer to which small amounts of additives have been added for coloration, antistatic properties, lubrication, hydrophilicity, etc. These additives, for example titanium dioxide for coloration, are generally present in an amount less than about 5 weight percent and more typically about 2 weight percent.

As used herein, the term “nonwoven web” refers to a web having a structure of individual fibers or threads which are interlaid, but not in a regular, repeating manner as in a woven or knitted fabric. Nonwoven webs or fabrics have been formed from many processes, such as, for example, meltblowing processes, spunbonding processes, hydroentangling processes, and bonded carded web processes. The basis weight of nonwoven fabrics is usually expressed in grams per square meter ( ) and the fiber diameters are usually expressed in microns. Fiber size can also be expressed in denier. The basis weight of nonwoven webs useful as components of the present invention, such as the facing layer (which can be a single layer or a composite of more than one layer), can range from 10 to 200.

The constituent fibers of nonwoven webs can be polymer fibers, which may include can be monocomponent, bicomponent and/or biconstituent, capillary channel fibers, having a major cross-sectional dimensions (e.g., diameter for round fibers) ranging from 5-200 microns. The constituent fibers can range from about 0.1 denier to about 100 denier.

As used herein, the term “polymer” generally includes, but is not limited to, homopolymers, copolymers, (such as for example, block, graft, random and alternating copolymers, terpolymers, etc.,)and blends and modifications thereof. In addition, unless otherwise specifically limited, the term “polymer” includes all possible geometric configurations of the material. The configurations include, but are not limited to, isotactic, atactic, syndiotactic, and random symmetries.

As used herein, “spunbond fibers” refers to small diameter fibers that are formed by extruding molten thermoplastic material as filaments from a plurality of fine, usually circular capillaries of a spinneret, with the diameter of the extruded filaments then being rapidly reduced. Spunbond fibers are generally not tacky when they are deposited on a collecting surface. Spunbond fibers are generally continuous and have average diameters (from a sample of at least 10) larger than 7 microns and more particularly between about 10 and 40 microns.

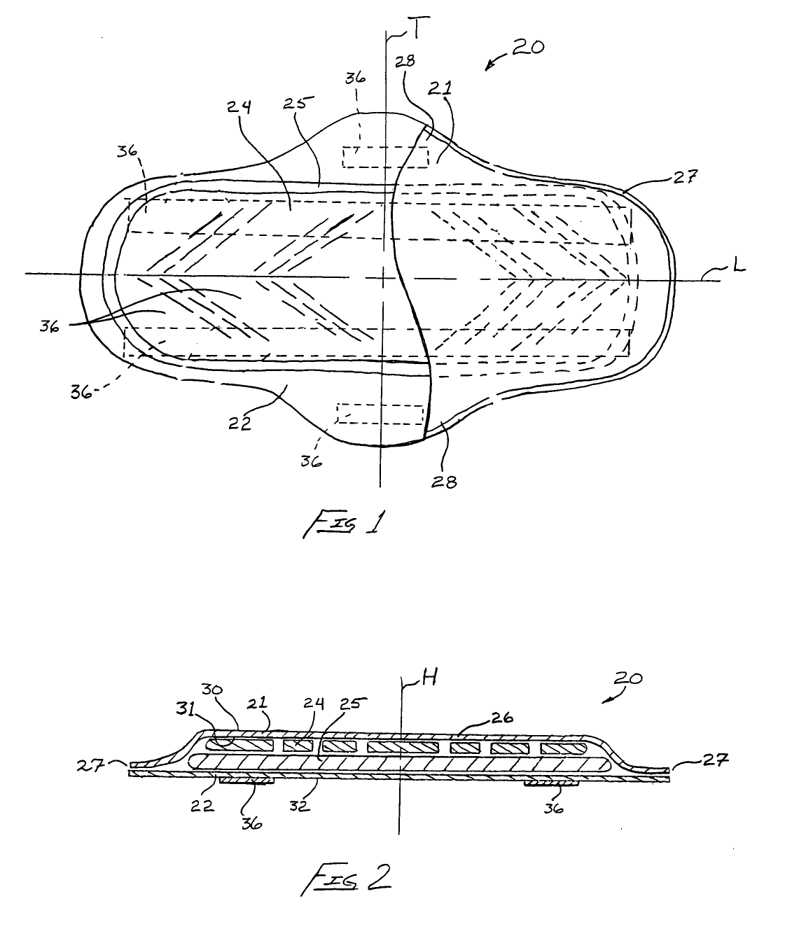

FIG. 1 and FIG. 2 show one embodiment of an absorbent article of the present invention. FIG. 1 and FIG. 2 show a sanitary napkin 20 comprising a fluid permeable facing layer 21, breathable backsheet 22, and a first absorbent layer 24 joined to the facing layer 21. Facing layer 21 and breathable backsheet 22 can be joined about a periphery 27. Facing layer 21 of sanitary napkin 20 can be a body-contacting layer commonly known in the art as a topsheet 26. Facing layer 21 can be a composite comprising a topsheet 26 and a second absorbent layer, not shown in FIG. 1 or FIG. 2, but also known in the art. An optional second absorbent layer 25 can be disposed between first absorbent layer 24 and breathable backsheet 22.

The sanitary napkin 20, as well as each layer or component thereof can be described as having a “body facing” surface and a “garment facing” surface. As can be readily understood by considering the ultimate use for sanitary napkins, the body facing surfaces are the surfaces of the layers or components that are oriented closer to the body of the user when in use, and the garment facing surfaces are the surfaces that are oriented closer to the undergarment of the user when in use. Therefore, for example, facing layer 21 has a body facing surface 30 and a garment facing surface 31 that is the surface that can be adhered to the underlying first absorbent layer 24. The garment facing surface 32 of the fluid impermeable backsheet 22 of a sanitary napkin, for example, is oriented closest to and may contact the wearer's panties in use (via adhesive attachment means, if used).

Sanitary napkin 20 can have side extensions 28, commonly referred to as “wings,” designed to wrap the sides of the crotch region of the panties of the user of sanitary napkin 20. Sanitary napkin 20 and/or wings 28 can have fastening means including attachment components, such as pressure sensitive adhesive, or mechanical fasteners such as hook and loop fasteners. The sanitary napkin 20 shown in FIG. 1 and FIG. 2 has strips of positioning adhesive 36 on the garment facing surface 32 of breathable backsheet 22. The positioning adhesive 36 can be a hot-melt adhesive material capable of establishing a temporary bond with the undergarment material. A suitable material is the composition designated HL-1491 XZP, commercially available from H. B. Fuller, Toronto, Ontario, Canada. The fastening means can include attachment components such as positioning adhesive 36, disposed on the extensions 28, as shown in FIG. 1 and FIG. 2. The positioning adhesive 36, or other attachment components can be applied to the garment facing surface 32 of the breathable backsheet 22 in various patterns including a complete adhesive coverage, parallel longitudinal strips or lines, a line of adhesive following the perimeter of the structure, transverse lines of adhesive, and the like, or any combination thereof.

In general, the presence of fastening means defines an attachment zone that is coextensive with the fastening means. The attachment zone is the portion of the sanitary napkin, typically the backsheet thereof, that is fixed with respect to the wearer's panties. The sanitary napkin 20 can be made by hand or on commercial high-speed production lines, as is known in the art.

Facing layer 21 may, in some embodiments, comprise extensible nonwoven materials or extensible apertured polymer films, as are known in the art for topsheets on disposable absorbent articles. For example, facing layer 21 can comprise an apertured polymer film sold under the trade name “DRI-WEAVE” by The Procter & Gamble Co., Cincinnati, Ohio, or an apertured formed film, as disclosed in U.S. Pat. No. 4,629,643, commercially available from Tredegar Film Products, Terre Haute, Ind. under the designation X27121. First absorbent layer 24 (and second absorbent layer 25, if used) and breathable backsheet 22 can comprise absorbent materials, and liquid impermeable film materials respectively, as is well known in the art. Extensions 28, if used, can be integral extensions of the facing layer or the backsheet or both, and they can be symmetric about the longitudinal axis L, transverse axis T, or both.

Nonwoven webs used in the present invention can be any known nonwoven webs or composites of two or more nonwoven webs. Joining of the facing layer 21 and the first absorbent layer 24 can be provided by any means known in the art, such as by adhesive bonding, thermal bonding, ultrasonic bonding, and the like. Alternatively, the facing layer 21 and first absorbent layer 24 can be joined in selected regions by thermal bonding, for example, by thermal spot bonding.

First and/or second absorbent layer can be Foley Fluff pulp (available from Buckeye Technologies Inc., Memphis, Tenn.) that is disintegrated and formed into a core having a density of about 0.07 grams per cubic centimeter (g/cm³) and a caliper of about 10 mm.

Joining of the facing layer 21 and the first absorbent layer 24 can be provided by any means known in the art, such as by adhesive bonding, thermal bonding, ultrasonic bonding, and the like. Complete bonding at interface is not necessary in some embodiments. In some embodiments, the facing layer 21 is adhered to the body-facing side of the first absorbent layer 24 at substantially the entire surface interface between the two components, such as by the use of meltblown thermoplastic adhesive. Adhesion can be provided by application of a substantially uniform layer of adhesive applied by means known in the art, such as by spraying or slot coating. The adhesive, if uniformly coated should not block fluid flow into the first absorbent layer 24. Therefore, in some embodiments, the adhesive is a fluid permeable adhesive, such as the aforementioned Findley HX1500-1 adhesive.

The absorbent article according to the present invention also comprises a breathable backsheet 22. The breathable backsheet 22 prevents the extrudes absorbed and contained in the absorbent structure from wetting the articles that contact the absorbent product, such as underpants, pants, pyjamas, undergarments, and shirts or jackets, thereby acting as a barrier to fluid transport. In addition, however, the breathable backsheet 22 of the present invention permits the transfer of at least water vapor, typically both water vapor and air, through the backsheet 22, and thus allows the circulation of air into and water vapor out of the article. The breathable backsheet 22 typically extends across the whole of the absorbent structure and can also extend into and form part or all of extensions 28, sideflaps, side wrapping elements or wings, if present.

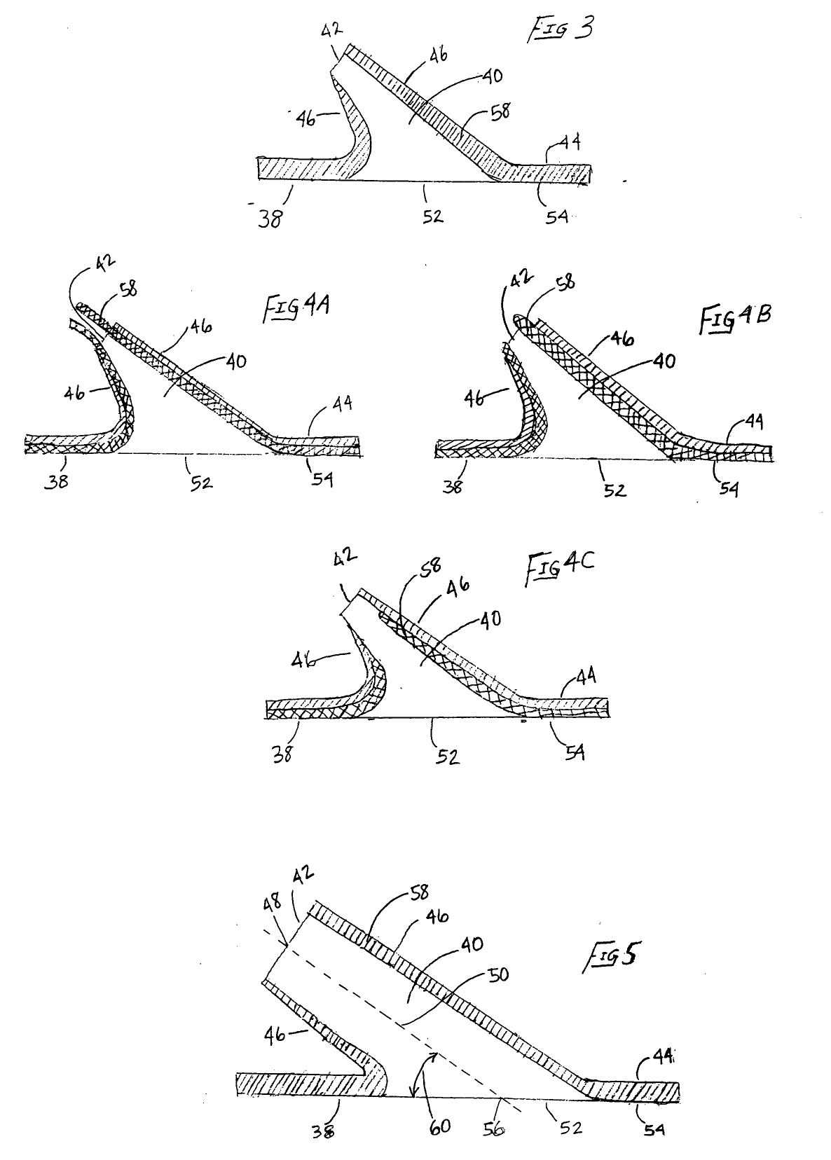

Suitable materials for use as a breathable backsheet 22 may include a resilient, three dimensional, fluid pervious polymeric web 38, as show in FIG. 3, FIG. 4A, FIG. 4B, FIG. 4C and FIG. 5. The polymeric web 38 comprises a first surface 44 and a second surface 54 generally parallel to and spaced apart from the first surface 44. The polymeric web 38 has a plurality of fluid passageways 40 comprising side walls 46 that extend between the first surface 44 and the second surface 54, to place the first surface 44 and the second surface 54 in fluid communication with one another. Each fluid passageway 40 has a first opening 42 on the first surface 44, a second opening 52 on the second surface 54, and the side walls 46 that connect the first opening 42 to the second opening 52. The breathable backsheet 22 may be used as a secondary backsheet with a nonwoven backsheet.

The polymeric web 38 of the present invention is comprised of an occluding material 58 that is blended or co-extruded with resins that typically comprise polymeric webs, such as a polyethylene (LDPE, LLDPE, MDPE, HDPE) or laminates thereof This occluding material 58 causes a mechanical change in the side walls 46 of the fluid passageways 40 upon contact with fluid that renders the first surface 44 and second surface 54 of the polymeric web 38 to be in non-fluid communication with one another at the fluid passageways 40. This mechanical change may include the side walls 46 of the fluid passageways 40 collapsing and/or adhering to one another such that first surface 44 and second surface 54 are in non-fluid communication with one another at the fluid passageways 40. The occluding materials 58 may include polymers such as polyurethanes, polyamides, polyester amides, polyether ester amides, cellulose derivatives, alkyl and methyl acrylates, polyvinyl alcohol, poly(2-ethyl oxazoline), polyethyleneimine, polyvinyl pyrrolidinone, polyamides, polyacrylamide, polymethylacrylamide and metal salts thereof, polyethylene glycol, and copolymers thereof, such as, copolymers of vinyl acetate and ethylene, copolymers of polyureas, copolymers of vinyl acetate and vinyl pyrrolidinone, copolymers of polyether amide, copolymers of polyether ester and the like. The occluding materials 58 may also include polyols such as sorbitol, mannitol, glycerol, sucrose, and the like. The occluding materials 58 may further include plasticizers such as esters of citric acid, triacetin, diacetin, sulfonamides, tartrates, benzoates, adipates, sebacates, sucrose esters, and the like. The occluding material 58 may also include mixtures of the aforementioned polymers, polyols, and plasticizers.

These occluding materials 58 may be blended or co-extruded with typical resins used in polymeric webs. When blended, such as shown in FIG. 3 and FIG. 5, the resilient, three dimensional, fluid pervious polymeric web 38 of the present invention may be a single layer. Alternatively, the resilient, three dimensional, fluid pervious polymeric web of the present invention may be co-extruded with at least another layer, as shown in FIG. 4A, FIG. 4B, and FIG. 4C. The resilient, three dimensional, fluid pervious polymeric web 38 of the present invention may be joined to at least one other layer, such that it is a double layer. The resilient, three dimensional, fluid pervious polymeric web 38 of the present invention may be joined to at least two layers, such that it is a triple layer. The resilient, three dimensional, fluid pervious polymeric web may be disposed between two or more layers. The occluding material 58 and the other resins can be heated close to their melting point and exposed through a forming screen to a suction force which pulls those areas exposed to the force into the forming apertures which are shaped such that the film is formed into that shape and, when the suction force is high enough, the film breaks at its end thereby forming an aperture through the film.

The occluding materials 58 may be totally exposed, partially exposed or not exposed at the first openings 42 of the fluid passageways 40 when they are formed. FIG. 4A shows the fluid passageway 40 of the three dimensional, fluid pervious polymeric web 38 with the occluding material 58 totally exposed at the first opening 42 of the fluid passageway 40. FIG. 4B shows the fluid passageway 40 of the three dimensional, fluid pervious polymeric web 38 with the occluding material 58 partially exposed at the first opening 42 of the fluid passageway 40. FIG. 4C shows the fluid passageway 40 of the three dimensional, fluid pervious polymeric web 38 with the occluding material 58 unexposed at the first opening 42 of the fluid passageway 40. It is believed that many parameters may allow one skilled in the art to tailor the exposure of the occluding materials. These parameters include, but are not limited to, type of polymer, basis weight of film, process temperature, process speed, air temperature and screen type. For example, if the occluding material 58 is the type of polymer that has higher cohesion and/or higher elongation than the other resins used in making the polymeric web 38, the occluding material 58 will become either totally or partially exposed at the first opening 42 of the fluid passageway 40. Further, if the occluding material 58 has a higher basis weight than the other resins used in making the polymeric web 38, the occluding material 58 will become either totally or partially exposed at the first opening 42 of the fluid passageway 40.

As show in FIG. 3, FIG. 4A, FIG. 4B, FIG. 4C and FIG. 5 the fluid passageways 40 may be funnel shaped, similar to those described in U.S. Pat. No. 3,929,135. The first opening 42 and second opening 52 of the fluid passageways 40 may be circular or non circular. As seen in FIG. 3, FIG. 4A, FIG. 4B, FIG. 4C and FIG. 5, the second opening 52 on the second surface 54 may have a cross sectional dimension or area greater than the cross-sectional dimension or area of the first opening 42 located on the first surface 44. Thus, the fluid passageways 40 in the polymeric web 38 may have a directional liquid transport and be positioned such that they support the prevention of liquid loss (leakage) through the breathable backsheet 22. The fluid passageways 40 may be evenly distributed across the entire surface of the layer and also may be identical in size.

Various forms, shapes, sizes and configurations of the fluid passageways 40 are possible. The fluid passageways 40 may extend away from the first surface 44 of the polymeric web 38 for a length that typically may be at least in the order of magnitude of the largest diameter of the opening while this distance can reach up to several times the largest opening. The fluid passageway 40 may have a first opening 42 in the plane of the first surface 44 of the film and a second opening 52 which is the opening formed when the suction force (such as a vacuum) in the above mentioned process creates the aperture. Naturally, the edge of the first opening 42 may be rugged or uneven, comprising loose elements extending from the edge of the opening. However, in most embodiments, the opening may be as smooth as possible, so as not to create a liquid transport entanglement between the extending elements at the end of the first opening 42 of the fluid passageway, with the first absorbent layer 25 in the sanitary napkin 20.

FIG. 5 shows the three dimensional, fluid pervious web of the present invention showing that fluid passageway 40 comprises a first opening 42 having a center point 48 and the second opening 52 also having a center point 56. The center points 48, 56 for non-circular openings are the area center points of the respective opening area. A center axis 50 is defined when the center point 48 of the first opening 42 are connected with the center point 56 of the second opening 52. This center axis 50 forms an angle 60 with the plane of the polymeric web 38, which is the same plane as the first surface 44 of the polymeric web 38. In most cases, the fluid passageways 40 extend away from the first surface 44 of polymeric web 38 at an angle 60, which is less then 90 degrees. In some embodiments, the angle 60 may range between 85 and 20 degrees. This angle 60 may also range, between 65 degrees and 25 degrees. This angle 60 may also range, between 55 and 30 degrees.

The fluid passageways 40 may take the shape of a funnel such that the first opening 42 is substantially smaller than the second opening 52 when considering the opening size in a plane perpendicular to the center axis 50. The fluid passageways 40 may be curved along their length towards the first surface of the polymeric web 38.

Methods for making such three-dimensional polymeric films with capillary apertures are identical or similar to those found in the apertured film topsheet references, the apertured-formed film references and the micro-/macroscopically expended film references such as U.S. Pat. No. 4,637,819 and U.S. Pat. No. 4,591,523.

The plurality of the fluid passageways 40 and the angle 60 of the fluid passageways 40 allows the polymeric web 38 to be air and vapor permeable. The occluding material 58 comprised in the polymeric web 38, allows the polymeric web 38 to be an effective moisture barrier. Without wishing to be bound by theory, it is believed that when the side walls 46 of the fluid passageways 40 are contacted with fluid, the side walls 46 of the fluid passageway 40 undergo a mechanical change, such as, collapsing and/or adhering to one another. The collapse and/or adherence causes the first surface 44 and the second surface 54 of the polymeric web 38 to no longer be in fluid communication. When the first surface 44 of the web and the second surface 54 of the polymeric web 38 are no longer in fluid communication an effective moisture barrier is formed.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the scope of the invention. It is therefore intended to cover in the appended claims all such changes and modifications that are within the scope of this invention.

1. A resilient, three dimensional, fluid pervious polymeric web comprising:
(a) a first surface and a second surface generally parallel to and spaced apart from said first surface;
(b) a plurality of fluid passageways comprising side walls extending between said first surface and said second surface to place said first surface and said second surface in fluid communication with one another; and
(c) an occluding material which causes a mechanical change in said side walls of said fluid passageways upon contact with fluid rendering said first surface and second surface to be in non-fluid communication with one another at said fluid passageways.

2. The resilient, three dimensional, fluid pervious polymeric web according to claim 1 wherein said web is a single layer.

3. The resilient, three dimensional, fluid pervious polymeric web according to claim 1 wherein said web is co-extruded with at least one other layer.

4. The resilient, three dimensional, fluid pervious polymeric web according to claim 3 wherein said web is joined to at least one other layer.

5. The resilient, three dimensional, fluid pervious polymeric web according to claim 3 wherein said web is joined to at least two layers.

6. The resilient, three dimensional, fluid pervious polymeric web according to claim 1 wherein said occluding material is selected from the group consisting of polyurethanes, polyamides, polyester amides, polyether ester amides, cellulose derivatives, alkyl and methyl acrylates, polyvinyl alcohol, poly(2-ethyl oxazoline), polyethyleneimine, polyvinyl pyrrolidinone, polyamides, polyacrylamide, polymethylacrylamide and metal salts thereof, polyethylene glycol, copolymers of vinyl acetate and ethylene, copolmers of polyureas, copolymers of vinyl acetate and vinyl pyrrolidinone, copolymers of polyether amide, copolymers of polyether, sorbitol, mannitol, glycerol, sucrose, he esters of citric acid, triacetin, diacetin, sulfonamides, tartrates, benzoates, adipates, sebacates, sucrose esters, and mixtures thereof.

7. The resilient, three dimensional, fluid pervious polymeric web according to claim 1 wherein said fluid passageways comprise a first opening on said first surface.

8. The resilient, three dimensional, fluid pervious polymeric web according to claim 7 wherein said occluding material is partially exposed at the first opening of the fluid passageway.

9. The resilient, three dimensional, fluid pervious polymeric web according to claim 7 wherein said occluding material is totally exposed at the first opening of the fluid passageway.

10. The resilient, three dimensional, fluid pervious polymeric web according to claim 7 wherein said occluding material is unexposed at the first opening of the fluid passageway.

11. An absorbent article comprising
(a) a fluid permeable facing layer;
(b) a breathable backsheet; and
(c) a first absorbent layer positioned between said fluid permeable facing layer and said breathable backsheet;
wherein said breathable backsheet comprises:
(i) a resilient, three dimensional, fluid pervious polymeric web comprising a first surface and a second surface generally parallel to and spaced apart from said first surface;
(ii) a plurality of fluid passageways comprising sidewalls extending between said first surface and said second surface to place said first surface and said second surface in fluid communication with one another; and
(iii) an occluding material which causes a mechanical change in said side walls of said fluid passageways upon contact with fluid rendering said first surface and second surface in non fluid communication with one another at said fluid passageways.

12. The absorbent article of claim 11 wherein the resilient, three dimensional, fluid pervious polymeric web is a single layer.

13. The absorbent article of claim 11 wherein the resilient, three dimensional, fluid pervious polymeric web is co-extruded with at least one other layer.

14. The absorbent article of claim 11 wherein the resilient, three dimensional, fluid pervious polymeric web is joined to at least one other layer.

15. The absorbent article of claim 11 wherein the resilient, three dimensional, fluid pervious polymeric web is joined to at least two layers.

16. The absorbent article of claim 11 wherein said occluding material is selected from the group consisting of polyurethanes, polyamides, polyester amides, polyether ester amides, cellulose derivatives, alkyl and methyl acrylates, polyvinyl alcohol, poly(2-ethyl oxazoline), polyethyleneimine, polyvinyl pyrrolidinone, polyamides, polyacrylamide, polymethylacrylamide and metal salts thereof, polyethylene glycol, copolymers of vinyl acetate and ethylene, copolmers of polyureas, copolymers of vinyl acetate and vinyl pyrrolidinone, copolymers of polyether amide, copolymers of polyether, sorbitol, mannitol, glycerol, sucrose, he esters of citric acid, triacetin, diacetin, sulfonamides, tartrates, benzoates, adipates, sebacates, sucrose esters, and mixtures thereof.

17. The absorbent article of claim 11 wherein said fluid passageways comprise a first opening on said first surface.

18. The absorbent article of claim 17 wherein said occluding material is partially exposed at the first opening of the fluid passageway.

19. The absorbent article of claim 17 said occluding material is totally exposed at the first opening of the fluid passageway.

20. The absorbent article of claim 17 said occluding material is unexposed at the first opening of the fluid passageway.
